(19) United States
(12) Patent Application Publication
(10) Pub. No.: US 2026/0360092 A1
(43) Pub. Date: Nov. 12, 2026

(54) WRITING ON VIRTUAL ANNOTATION SURFACE

(71) Applicant: GOOGLE LLC, Mountain View, CA (US)

(72) Inventors: Stiven Guillaume Francois Morvan, New York City, NY (US); Yodahe Alemu, New York, NY (US); Dongeek Shin, San Jose, CA (US)

(21) Appl. No.: 19/515,146

(22) PCT Filed: Oct. 11, 2023
(86) PCT No.: PCT/US2023/076554

§ 371 Date: Feb. 27, 2026

(51) Int. Cl. G06T 19/00; G06F 3/01; G06V 20/20

(52) U.S. Cl. CPC G06T 19/006; G06F 3/016; G06F 3/017; G06V 20/20

(57) ABSTRACT

A method performed by a computing device can include determining that a user is writing on a virtual annotation surface based on a portion of a hand of the user being within a threshold distance of the virtual annotation surface and the hand forming a predetermined gesture, and based on determining that the user is writing on the virtual annotation surface, providing haptic feedback to the user.

### TECHNICAL FIELD

This description relates to augmented reality.

### BACKGROUND

Computing devices can overlay images against a physical environment.

### SUMMARY

A computing device determines that a user is writing on a virtual annotation surface based on a portion of a hand of the user being within a threshold distance of a location of the virtual annotation surface and the hand forming a predetermined gesture. The predetermined gesture can be a pinching gesture. Based on determining that the user is writing on the virtual annotation surface, the computing device provides haptic feedback to the user. The haptic feedback can include vibrations by a wearable device such as a watch or ring. The computing device can present the virtual annotation surface. The computing device can present a virtual stroke based on locations, and/or movement, of the portion of the hand of the user. The computing device can include a head-mounted device such as an augmented reality headset which may include a display for presenting the virtual annotation surface and/or the stroke.

According to an implementation, a method performed by a computing device comprises determining that a user is writing on a virtual annotation surface based on a portion of a hand of the user being within a threshold distance of the virtual annotation surface and the hand forming a predetermined gesture, and based on determining that the user is writing on the virtual annotation surface, providing haptic feedback to the user.

According to an implementation, a non-transitory computer-readable storage medium includes instructions stored thereon. When executed by at least one processor, the instructions are configured to cause a computing device to determine that a user is writing on a virtual annotation surface based on a portion of a hand of the user being within a threshold distance of the virtual annotation surface and the hand forming a predetermined gesture, and based on determining that the user is writing on the virtual annotation surface, provide haptic feedback to the user.

A computing device comprises at least one processor and a non-transitory computer-readable storage medium comprising instructions stored thereon. When executed by the at least one processor, the instructions are configured to cause the computing device to determine that a user is writing on a virtual annotation surface based on a portion of a hand of the user being within a threshold distance of the virtual annotation surface and the hand forming a predetermined gesture, and based on determining that the user is writing on the virtual annotation surface, provide haptic feedback to the user.

The details of one or more implementations are set forth in the accompanying drawings and the description below. Other features will be apparent from the description and drawings, and from the claims.

### BRIEF DESCRIPTION OF THE DRAWINGS

FIG. 1 shows a user making a predetermined gesture near a virtual annotation surface.

FIG. 2A shows an indication that a portion of a hand of the user is approaching the virtual annotation surface.

FIG. 2B shows an indication that the portion of the hand of the user is beyond the virtual annotation surface.

FIG. 3 is a flowchart of a method for providing feedback and presenting a stroke in response to a gesture.

FIG. 4 is a block diagram of a computing device for providing feedback and presenting a stroke in response to a gesture.

FIGS. 5A, 5B, and 5C show an implementation of a head-mounted device.

FIG. 5D shows another implementation of the head-mounted device.

FIG. 6 is a flowchart of a method for providing feedback in response to a gesture.

Like reference numbers refer to like elements.

### DETAILED DESCRIPTION

A computing device, such as a head-mounted device and/or head-mounted display, can present a virtual annotation surface. The virtual annotation surface can be presented in the air, displaced from the display and any other solid physical objects. A virtual annotation surface can be a virtual surface onto which a user can annotate, draw, and/or write. A computing device, which can be the same computing device that presents the virtual annotation surface or a different computing device, can monitor hand movements of the user. The monitoring of hand movements can include determining whether the user is making a gesture with a hand of the user and/or determining a location of the hand of the user.

The computing device monitoring the hand of the user can determine whether the user is writing on the virtual annotation surface. The computing device monitoring the hand of the user can determine whether the user is writing on the virtual annotation surface based on whether a location of the hand of the user is on and/or within a threshold distance of the virtual annotation surface and whether the user is making the predetermined gesture. A technical problem with writing on a virtual annotation surface is a lack of haptic feedback. If a user were writing on a virtual surface overlaid on a desk or table, the user would feel the contact with the desk or table. Without a solid physical object, the user does not feel the contact with the virtual annotation surface, making it difficult for the user to determine whether the location of the hand of the user is on the virtual annotation surface.

If the computing device monitoring the hand of the user determines that the user is writing on the virtual annotation surface, then the computing device monitoring the hand of the user can provide output and/or feedback to the user. The output and/or feedback when the user is writing on the virtual annotation surface is a technical solution to the technical problem of the user not feeling the contact with the virtual annotation surface. The computing device can provide the output and/or feedback when the location of the hand of the user is on and/or within a threshold distance of the virtual annotation surface. The output and/or feedback can include the computing device instructing a wearable device worn on an arm, wrist, or hand of the user to provide haptic feedback such as vibration to indicate that the user is writing on the virtual annotation surface. The computing device monitoring the hand of the user can also cause the display to present a virtual stroke on the virtual annotation surface (the virtual location of the virtual annotation surface being displaced from the display). The virtual stroke can represent the user writing on the virtual annotation surface. The technical solution of output and/or feedback when the user is writing on the virtual annotation surface has the technical benefit of easily enabling the user to know whether the user has placed the hand of the user in a correct location on or near the virtual annotation surface. This technical solution enables the computing device to present the virtual annotation surface anywhere within reach of the user, without need of a physical object onto which to overlay the virtual annotation surface.

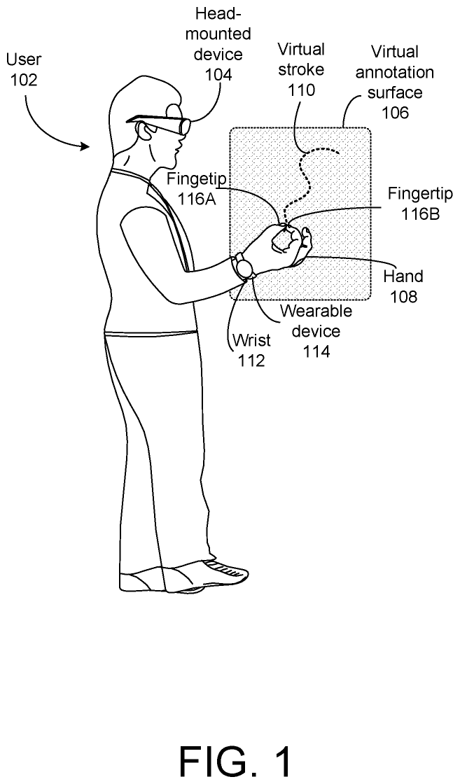

FIG. 1 shows a user 102 making a predetermined gesture near a virtual annotation surface 106. In this implementation, the user 102 is wearing a head-mounted device 104. The head-mounted device 104 can include smartglasses or a virtual reality headset. The head-mounted device 104 includes a display that generates and/or presents the virtual annotation surface 106 to the user 102 at a virtual location spatially displaced from the display. The display included in the head-mounted device 104 can be considered a head-mounted display. The display included in the head-mounted device 104 can generate and/or present the virtual annotation surface 106 against a background of physical objects seen by the user 102. In some implementations, the virtual annotation surface 106 is colored. In some implementations, the virtual annotation surface 106 is translucent and/or semitransparent, allowing the user 102 to see physical objects behind the virtual annotation surface 106. In some implementations, the head-mounted device 104 includes a processor that performs any combination of the functions and/or determinations described herein. In some implementations, another computing device, such as a wearable device 114 and/or another computing device in communication with the head-mounted device 104 and/or wearable device 114, performs any combination of the functions and/or determinations described herein.

The head-mounted device 104 includes one or more cameras. The one or more cameras included in the head-mounted device 104 capture images in front of the user 102. The one or more cameras included in the head-mounted device 104 can capture images of a hand 108 of the user 102. The head-mounted device 104, and/or another computing device in communication with the head-mounted device 104, can determine a location of the hand 108 based at least in part on the images captured by the camera included in the head-mounted device 104. The head-mounted device 104, and/or another computing device in communication with the head-mounted device 104, can determine a gesture formed by the hand 108 based at least in part on the images captured by the camera included in the head-mounted device 104.

The wearable device 114 can be worn on an appendage, such as a portion of an arm, of the user 102. The wearable device 114 can include a band worn around a wrist 112 of the user 102, a watch or smartwatch worn around the wrist 112 of the user 102, or a ring worn around a finger of the user 102, as non-limiting implementations. The wearable device 114 can include an accelerometer and/or inertial measurement unit (IMU) that measures acceleration of the wearable device 114. Acceleration of the wearable device 114 can be caused by movement of the wrist 112 and/or hand 108 of the user 102. The wearable device 114 can transmit and/or send measured acceleration to the head-mounted device 104 and/or to another computing device.

When the user 102 desires to draw and/or write on the virtual annotation surface 106, the user 102 can form a predetermined gesture with the hand 108 of the user 102. The predetermined gesture can include a pinching gesture or tapping gesture, as non-limiting implementations. The computing device, such as the head-mounted device 104, the wearable device 114, and/or another computing device in communication with the head-mounted device 104 and/or wearable device 114, can recognize the predetermined gesture based on images captured by the camera included in the head-mounted device 104 and/or the acceleration measured by the wearable device 114.

In the implementation shown in FIG. 1, the user 102 is making and/or forming a pinching gesture with the hand 108 of the user 102. The pinching gesture is formed by a first fingertip 116A of a first finger (which can be a thumb) of the hand 108 contacting and/or pressing against a second fingertip 116B of a second finger of the hand 108.

The computing device, which can include the head-mounted device 104, the wearable device 114, and/or another computing device in communication with the head-mounted device 104 and/or wearable device 114, can respond to recognizing the predetermined gesture by determining whether a portion of the hand 108, such as a portion of the hand 108 forming the gesture (such as the fingertips 116A, 116B), is sufficiently close to a portion of the virtual annotation surface 106. The computing device can determine whether the portion of the hand 108 is sufficiently close to the virtual annotation surface 106 by determining whether the portion of the hand 108 is within a threshold distance of a portion of the virtual annotation surface 106 that is closest to the portion of the hand 108. If the computing device determines that the portion of the hand 108 is sufficiently close to the virtual annotation surface 106, then the computing device causes the wearable device 114 to provide haptic feedback to the user 102. The haptic feedback can include the wearable device 114 vibrating.

If the computing device determines that the hand 108 is forming the predetermined gesture and that the portion of the hand 108 is sufficiently close to the virtual annotation surface 106, then the computing device can determine whether the hand 108 and/or portion of the hand 108 is moving. The computing device can determine whether the hand 108 and/or portion of the hand 108 is moving based on images captured by the camera(s) included in the head-mounted device 104 and/or based on acceleration measured by the wearable device 114. If the computing device determines that the hand 108 and/or portion of the hand 108 is moving, then the display included in the head-mounted device 104 can generate a virtual stroke 110 that is presented on the virtual annotation surface 106. The display included in the head-mounted device 104 presents the virtual stroke 110 on the virtual annotation surface 106. The virtual stroke 110 can be based on the movement of the hand 108 and/or portion of the hand 108. In some implementations, the virtual stroke 110 corresponds to the movement of the hand 108 and/or portion of the hand 108 along, and/or within the threshold distance of, the virtual annotation surface 106. The virtual stroke 110 can include one stroke or multiple strokes. In some implementations, the virtual stroke 110 includes letters and/or numbers written by the user 102 onto the virtual annotation surface 106. In some implementations, the virtual stroke 110 includes shapes, lines, and/or curves that form part of a picture or drawing that the user 102 draws.

In some implementations, if the computing device determines that the hand 108 is making the predetermined gesture but the hand 108 and/or portion of the hand 108 is not within the threshold distance from the virtual annotation surface 106, the computing device can cause the display included in the head-mounted device 104 to present an indicator. The indicator can indicate that the hand 108 and/or portion of the hand 108 is not within the threshold distance from the virtual annotation surface 106. The indicator can be different depending on whether the hand 108 and/or portion of the hand 108 is approaching the virtual annotation surface 106 (i.e. the hand 108 and/or portion of the hand 108 is between a body of the user 102 and the virtual annotation surface 106) or the hand 108 and/or portion of the hand 108 is beyond the virtual annotation surface 106 (i.e. the hand 108 and/or portion of the hand 108 is in a direction away from a body of the user 102 from the virtual annotation surface 106).

In some implementations, the indicator can be binary, indicating that the hand 108 and/or portion of the hand 108 is not within the threshold distance from the virtual annotation surface 106. In some implementations, the indicator can include haptic feedback, such as a first type of haptic feedback indicating that the hand 108 and/or portion of the hand 108 is not within the threshold distance from the virtual annotation surface 106 and a second, different type of haptic feedback indicating that the hand 108 and/or portion of the hand 108 is within the threshold distance from the virtual annotation surface 106. In some implementations, the indicator can be visual, with the computing device presenting an indication on a display of the computing device indicating whether the hand 108 and/or portion of the hand 108 is or is not within the threshold distance from the virtual annotation surface 106. In some implementations, the indicator can be auditory, with a speaker included in the computing device outputting an auditory indication whether the hand 108 and/or portion of the hand 108 is or is not within the threshold distance from the virtual annotation surface 106. In some implementations, the indicator can indicate a distance of the hand and/or portion of the hand 108 from the virtual annotation surface 106.

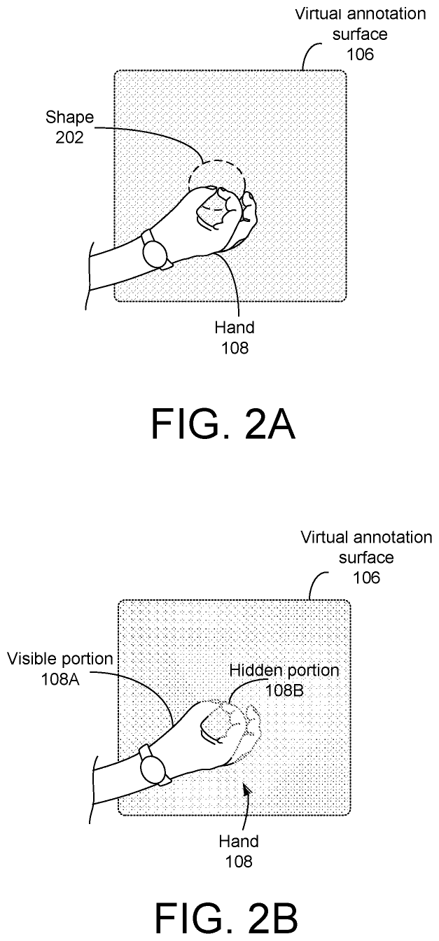

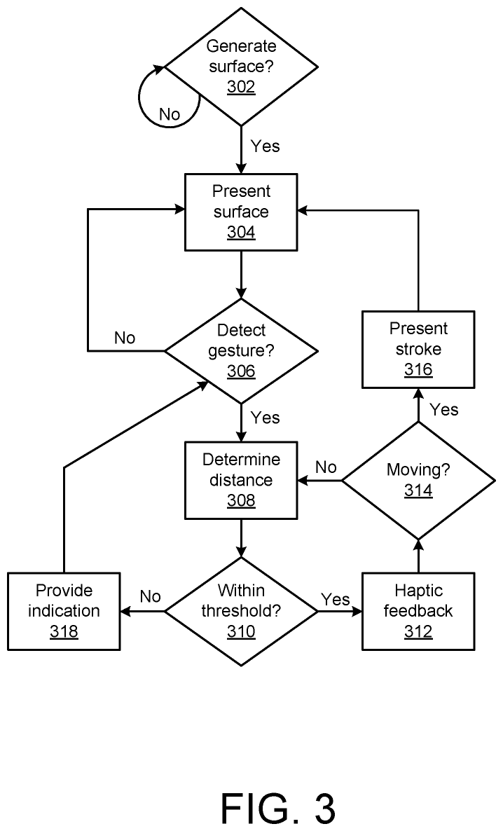

FIG. 2A shows an indication that a portion of a hand 108 of the user 102 (not labeled in FIG. 2A) is approaching the virtual annotation surface 106. In this implementation, the computing device has determined that the portion of the hand 108 is not within the threshold distance of the virtual annotation surface 106. In this implementation, the computing device has determined that the portion of the hand 108 is in a direction of the body of the user 102 from the virtual annotation surface 106 and/or is between the user 102 and the virtual annotation surface 106. Based on the determination that the portion of the hand 108 is not within the threshold distance of the virtual annotation surface 106 and/or that the portion of the hand 108 is in a direction of the body of the user 102 from the virtual annotation surface 106, the display included in the head-mounted device 104 presents an indication that the portion of the hand 108 is approaching the virtual annotation surface 106. The indication can include the display presenting a shape 202 on the virtual annotation surface 106. The shape 202 can be centered, near, proximal to, and/or overlay a closest portion of the virtual annotation surface 106 to the portion of the hand 108 forming the gesture. In the implementation shown in FIG. 2A, a portion of the shape 202 is behind the hand 108 and/or not visible over the hand 108. In the implementation shown in FIG. 2A, the shape 202 is a circle. However, the shape 202 can also be an oval, ellipse, rectangle, cross, or other shape, icon, or pattern.

In some implementations, a size of the shape 202 is a function of the distance of the portion of the hand 108 from the virtual annotation surface 106. The shape 202 can be larger when the portion of the hand 108 is farther from the virtual annotation surface 106. The shape 202 can be smaller when the portion of the hand 108 is closer to the virtual annotation surface 106. The shape 202 can shrink and/or reduce in size as the distance between the portion of the hand 108 and the virtual annotation surface 106 becomes smaller and/or when the portion of the hand 108 moves toward the virtual annotation surface 106. The shape 202 can disappear when the distance is within the threshold distance. The shape 202 can expand and/or increase in size as the distance between the portion of the hand 108 and the virtual annotation surface 106 becomes larger and/or when the portion of the hand 108 moves away from the virtual annotation surface 106.

FIG. 2B shows an indication that the portion of the hand 108 of the user 102 (not labeled in FIG. 2B) is beyond the virtual annotation surface 106. In this implementation, the display included in the head-mounted device 104 causes the virtual annotation surface 106 to cover and/or overlay a portion of the hand 108 that is beyond the virtual annotation surface 106. In FIG. 2B, a hidden portion 108B of the hand 108 is shown in dotted lines. The hidden portion 108B is the portion of the hand 108 that is beyond the virtual annotation surface 106 and is not visible to the user 102 because the hidden portion 108B is covered and/or overlaid by the virtual annotation surface 106. A visible portion 108A of the hand 108 is shown in solid lines. The visible portion 108A is closer to the user 102 than the virtual annotation surface 106 and/or between the user 102 and the virtual annotation surface 106. The visible portion 108A visible to the user 102 because the visible portion 108A is not covered and/or overlaid by the virtual annotation surface 106. The proportion of the hand 108 that is beyond the virtual annotation surface 106 and/or overlaid by the virtual annotation surface 106 indicates to the user the distance of the hand 108 and/or portion of the hand 108 from the virtual annotation surface 106.

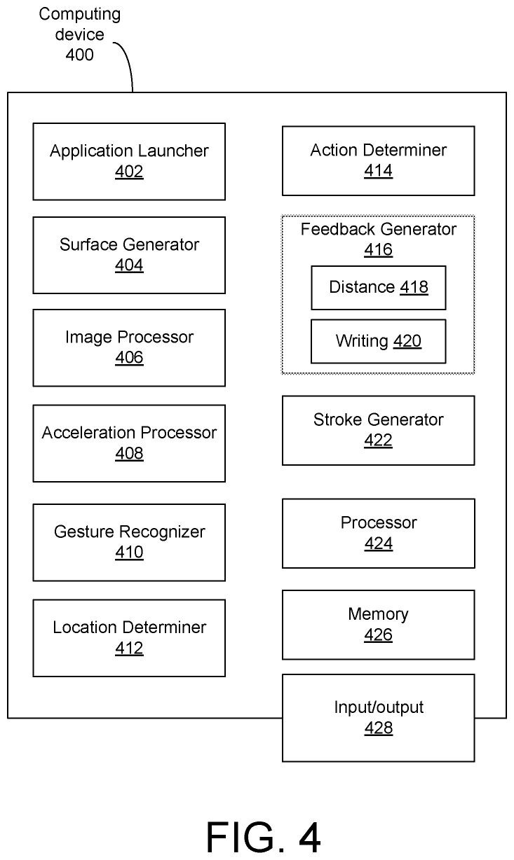

FIG. 3 is a flowchart of a method for providing feedback and presenting a stroke in response to a gesture. The method can be performed by a computing device, such as the head-mounted device 104, the wearable device 114, a computing device in communication with the head-mounted device 104 and/or wearable device 114, and/or distributed between any combination of these computing devices.

The computing device can determine whether to generate a virtual annotation surface 106 (302). The computing device can determine whether to generate the virtual annotation surface 106 (302) based, for implementation, on user input or in response to an event. In some implementations, determining whether to generate the virtual annotation surface 106 based on user input can include determining to generate the virtual annotation surface 106 in response to receiving tactile input indicating a request for the virtual annotation surface 106. In some implementations, determining whether to generate the virtual annotation surface 106 based on user input can include determining to generate the virtual annotation surface 106 in response to processing and/or recognizing a gesture represented by multiple photographs captured by a camera. In some implementations, determining whether to generate the virtual annotation surface 106 based on user input can include determining to generate the virtual annotation surface 106 in response to processing and/or recognizing an auditory and/or oral request to generate the virtual annotation surface 106. Determining whether to generate the virtual annotation surface 106 in response to an event can include determining to generate the virtual annotation surface 106 in response to launching of an application. The application can include a drawing application or a note-taking application. If the computing device determines not to generate the virtual annotation surface 106, then the computing device can continue determining whether to generate the virtual annotation surface 106 (302).

If the computing device determines to generate the virtual annotation surface 106, then the computing device can present the virtual annotation surface 106 (304). The computing device can present the virtual annotation surface 106 (304) by presenting the virtual annotation surface 106 using a display included in the head-mounted device 104, e.g., by instructing the head-mounted device 104 to present the virtual annotation surface 106 on the display included in the head-mounted device 104 at a virtual location spaced apart from the display. The display included in the head-mounted device 104 will present the virtual annotation surface 106 at a virtual location away from the display and/or head-mounted device 104.

While presenting the virtual annotation surface 106 (304), the computing device can determine whether the computing device detects and/or recognizes a predetermined gesture (306). The predetermined gesture can be included in a library of predetermined gestures (which can be considered a gesture library). The predetermined gesture is stored in the library of predetermined gestures before the virtual annotation surface 106 is presented. The predetermined gesture can include a static arrangement of, and/or relationship between, fingers and/or thumbs, and/or a dynamic movement or sequence of locations of fingers and/or thumbs with respect to each other. The predetermined gesture can include a pinching gesture or a tapping gesture.

The computing device can determine whether the computing device detects and/or recognizes the predetermined gesture (306), and/or determine whether the user 102 has formed a predetermined gesture with the hand 108 of the user 102, based on images captured by a camera included in the head-mounted device 104. In some implementations, the computing device can determine whether the user 102 formed the predetermined gesture by comparing images of the hand 108 of the user 102 to gestures included in the gesture library. In some implementations, the computing device determines and/or generates hand landmarks (or hand keypoints) based on the captured images, and compares the hand landmarks (or hand keypoints) to the predetermined gestures included in the gesture library to determine whether the user 102 formed the predetermined gesture. If the computing device determines that the computing device has not detected a gesture, then the computing device continues presenting the virtual annotation surface 106 (304).

If the computing device determines that the gesture was detected, then the computing device determines a distance of the hand 108 from the virtual annotation surface 106 (308), i.e., from the virtual location of the virtual annotation surface 106 outside the display of head-mounted device 104. The computing device can determine the distance of the hand 108 from the virtual annotation surface 106 (308) based on one or more images captured by a camera included in the head-mounted device 104. In some implementations, the camera included in the head-mounted device 104 includes a color camera, such as a red-green-blue (RGB) camera. In some implementations, the camera included in the head-mounted device 104 includes a depth camera. In some implementations, the computing device determines a distance of a portion of the hand 108 that is closest to the virtual annotation surface 106 from the virtual annotation surface 106. In some implementations, the computing device determines a distance of a specific portion of the hand 108, such as the fingertip(s) that are in contact with each other, from a closest portion of the virtual annotation surface 106. The determined distance can indicate whether the portion of the hand 108 is between the virtual annotation surface 106 and the user 102 (the portion of the hand 108 is approaching the virtual annotation surface 106) or the virtual annotation surface 106 is between the user 102 and the hand 108 (the portion of the hand 108 is beyond the virtual annotation surface 106).

After determining the distance (308), the computing device determines whether the distance is within a distance threshold (310). The computing device determines whether the distance is within the distance threshold (310) by comparing the determined distance to a distance threshold (or threshold distance). The distance threshold can be a predetermined distance, such as one centimeter, half of a centimeter, or a quarter of a centimeter. In some implementations, the distance threshold is the same whether the portion of the hand 108 is between the virtual annotation surface 106 and the user 102 or the portion of the hand 108 is beyond the virtual annotation surface 106. In some implementations, the distance threshold is different depending on whether the portion of the hand 108 is between the virtual annotation surface 106 and the user 102 or the portion of the hand 108 is beyond the virtual annotation surface 106.

If the distance is not within the distance threshold, then the computing device will provide an indication (318). The indication (318) can indicate whether the distance is or is not within the distance threshold. The indication (318) can include visual, haptic, and/or auditory feedback. In some implementations, the indication will indicate the distance. In some implementations, the indication of the distance is different depending on whether the hand 108 is between the user 102 and the virtual annotation surface 106 or the virtual annotation surface 106 is between the user 102 and the hand 108. In some implementations, the indication of the distance can be a shape or icon with a size proportional to the distance between the hand 108 and the virtual annotation surface 106 when the hand 108 is between the user 102 and the virtual annotation surface 106, as shown and described with respect to FIG. 2A. In some implementations, the indication of the distance includes obscuring a portion of the hand 108 that is beyond the virtual annotation surface 106 when the virtual annotation surface 106 is between the user 102 and the hand 108, as shown and described with respect to FIG. 2B. After providing the indication (318) of the distance, the computing device determines whether a gesture is detected (306), giving the user 102 the opportunity to maintain the predetermined gesture and place the predetermined gesture at or near the virtual annotation surface 106.

If the computing device determines that the distance is within the threshold distance, then the computing device can cause the wearable device 114 to provide haptic feedback (312) to the user 102. The wearable device 114 can provide haptic feedback to the user 102 by vibrating, causing a physical sensation in the user 102 at the point(s) of contact with the wearable device 114. The point(s) of contact can be the wrist 112 of the user 102 or a finger of the user 102, as non-limiting implementations.

In some implementations, after causing the wearable device 114 to provide haptic feedback (312), the computing device can determine whether the hand 108 of the user 102 and/or portion of the hand 108 of the user 102 is moving (314). In some implementations, the computing device determines whether the hand 108 or portion of the hand 108 is moving based on accelerometer measurements measured by the wearable device 114. In some implementations, the computing device determines whether the hand 108 or portion of the hand 108 is moving based on multiple images captured by one or more cameras included in the head-mounted device 104. In some implementations, the computing device determines whether the hand 108 or portion of the hand 108 is moving based on a combination of accelerometer measurements measured by the wearable device 114 and multiple images captured by one or more cameras included in the head-mounted device 104.

In some implementations, the computing device causes the wearable device 114 to provide haptic feedback based on determining that the predetermined gesture has been detected, the hand 108 and/or portion of the hand 108 is within the threshold distance of the virtual annotation surface 106, and that the hand 108 and/or portion of the hand 108 is moving.

If the computing device determines that the hand 108 and/or portion of the hand 108 is not moving, then the computing device can resume determining the distance (308) and/or determining whether the predetermined gesture is detected (306).

If the computing device determines that the hand 108 and/or portion of the hand 108 is moving, then the computing device can present a stroke (316). The stroke can be a virtual stroke. Presenting a stroke (316) can include presenting a line, curve, or path along the virtual annotation surface 106 corresponding to the movement of the hand 108 and/or portion of the hand 108. After presenting the stroke (316), the computing device can continue presenting the virtual annotation surface 106 (304).

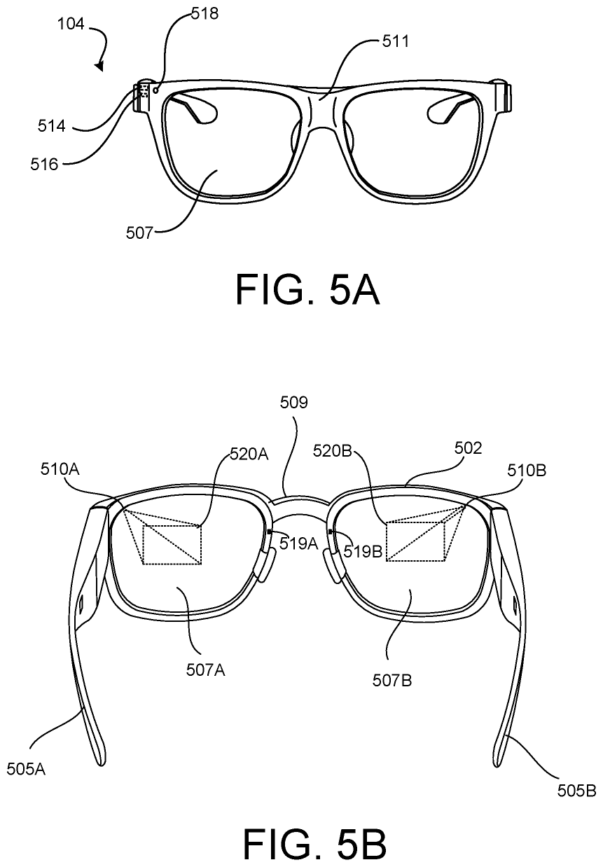

FIG. 4 is a block diagram of a computing device 400 for providing feedback and presenting a stroke in response to a gesture. The computing device 400 can represent the head-mounted device 104, the wearable device 114, a computing device in communication with the head-mounted device 104 and/or wearable device 114, and/or a combination of features and/or functions performed by and/or distributed between the head-mounted device 104, the wearable device 114, a computing device in communication with the head-mounted device 104 and/or wearable device 114.

The computing device 400 can include an application launcher 402. The application launcher 402 can launch an application in response to user input or other events. The user input can include a button press on the head-mounted device 104, a spoken or oral instruction, a selection (such as a tap) within a virtual user interface presented by a display included in the head-mounted device 104, a selection (such as a tap) on a user interface presented by a display included in the wearable device 114, and/or input into a human interface device (HID) included in a computing device in communication with the head-mounted device 104 and/or wearable device 114. The application can include a drawing application, an annotation application, or a notes or note-taking application.

The computing device 400 can include a surface generator 404. The surface generator 404 can generate a virtual surface for writing on, such as the virtual annotation surface 106. In some implementations, the surface generator 404 generates the virtual surface in response to the application launcher 402 launching an application, such as a drawing application, an annotation application, or a notes or note-taking application. In some implementations, the surface generator 404 generates the virtual surface in response to an instruction within an application to generate the virtual surface. The surface generator 404 can generate the virtual surface by presenting the virtual surface on a display included in the head-mounted device 104.

The computing device 400 can include an image processor 406. In some implementations, the image processor 406 includes one or more cameras, such as one or more cameras included in the head-mounted device 104. In some implementations, the image processor 406 is a function implemented by a processor included in the head-mounted device 104, wearable device 114, and/or a computing device in communication with the head-mounted device 104 and/or wearable device 114 that can process images captured by one or more cameras included in the head-mounted device 104. In some implementations, the image processor 406 can perform functions based on the images, such as abstracting information from the images by performing hand landmark and/or hand keypoint detection on images that include the hand 108 and/or portions of the hand 108 to find joints of the fingers of the hand 108 and/or fingertips 116A, 116B of fingers of the hand 108.

The computing device 400 can include an acceleration processor 408. In some implementations, the acceleration processor 408 includes an accelerometer and/or inertial measurement unit (IMU) included in the wearable device 114. In some implementations, the acceleration processor 408 is a function implemented in a processor included in the head-mounted device 104, wearable device 114, and/or a computing device in communication with the head-mounted device 104 and/or wearable device 114 that can process accelerometer measurements measured by the wearable device 114. In some implementations, the wearable device 114 can perform functions on the accelerometer measurements, such as smoothing the values of the accelerometer measurements to eliminate and/or reduce outlier measurements.

The computing device 400 can include a gesture recognizer 410. The gesture recognizer 410 can recognize predetermined gestures, such as pinches and/or taps, based on images captured by one or more cameras included in the head-mounted device 104 and/or acceleration measured by the wearable device 114. In some implementations, the gesture recognizer 410 compares images captured by one or more cameras to predetermined gestures stored in a gesture library. In some implementations, the gesture recognizer 410 compares hand keypoints, joints, and/or fingertips found by the image processor 406 to predetermined gestures stored in the gesture library. In some implementations, the gesture recognizer 410 compares changes of images, keypoints, joints, and/or fingertips to predetermined gestures stored in the gesture library. In some implementations, the gesture recognizer 410 compares accelerometer measurements measured by an accelerometer included in the wearable device 114 and/or processed by the acceleration processor 408 to predetermined gestures stored in the gesture library. The gesture recognizer 410 can identify the recognized gesture, such as identifying the recognized gesture as a pinch, a tap, or a swipe, as non-limiting implementations. The gesture recognizer 410 can recognize a tap based on two rapid and opposite changes in measured acceleration (such as within ten degrees of opposite directions and within ten percent of magnitude). The gesture recognizer 410 can prompt an action based on the identified and/or recognized gesture, such as launching an application, selecting a menu item, or determining a distance (308). In some implementations, the recognizer 410 includes a neural network such as a convolutional neural network (CNN) that has been trained to recognize predetermined gestures.

The computing device 400 can include a location determiner 412. The location determiner 412 can determine a location of a hand 108 or portion of a hand 108 of the user 102. The location determiner 412 can determine the location of the hand 108 or portion of the hand 108 of the user 102 with respect to the virtual annotation surface 106. The location determiner 412 can determine a location of a hand 108 or portion of a hand 108 of the user 102 based on images captured by one or more cameras included in the head-mounted device 104. The location determiner 412 can determine a location of a hand 108 or portion of a hand 108 of the user 102 based on images captured by one or more cameras included in the head-mounted device 104 based on triangulating the location of the hand 108 and/or portion of the hand 108 within multiple images captured by different cameras, or based on triangulating the location of the hand 108 and/or portion of the hand 108 within multiple images captured by the same camera at different times and at different angles. The location determiner 412 can determine the distance of the hand 108 and/or portion of the hand 108 from the virtual annotation surface 106 based on the determined location of the hand 108 and/or portion of the hand 108.

The computing device 400 can include an action determiner 414. The action determiner 414 can determine an action for the computing device 400 and/or a computing device in communication with the computing device 400 to perform. In some implementations, the action determiner 414 can determine the action based on touch input from a user into a button or touchscreen of the head-mounted device 104 and/or wearable device 114. In some implementations, the action determiner 414 can determine the action based on audio and/or spoken input received by a microphone included in the head-mounted device 104 and/or wearable device 114.

In some implementations, the action determiner 414 can determine the action based on the gesture recognized by the gesture recognizer 410 and/or the location of the hand 108 and/or portion of the hand 108 determined by the location determiner 412. The action determiner 414 can determine that the head-mounted device 104 and/or wearable device 114 should provide feedback to the user 102 based on gesture recognizer 410 determining that the hand 108 of the user 102 has formed a predetermined gesture (such as a pinch) and based on the distance determined by the location determiner 412.

The computing device 400 can include a feedback generator 416. The feedback generator 416 can generate feedback to the user 102 based in part on the action determined by the action determiner 414.

In some implementations, the feedback generator 416 can generate feedback indicating a distance 418. The feedback generator 416 can generate feedback indicating the distance 418 when the distance determined by the location determiner 412 indicates that a distance between the hand 108 and/or portion of the hand 108 is not within a threshold distance of the virtual annotation surface 106. When the distance determined by the location determiner 412 indicates that the distance between the hand 108 and/or portion of the hand 108 is not within the threshold distance (and/or is beyond the threshold distance) of the virtual annotation surface 106, the distance 418 indication generated by the feedback generator 416 can indicate the distance between the hand 108 and/or portion of the hand 108 and the virtual annotation surface 106. If the hand 108 and/or portion of the hand 108 is between the user 102 and the virtual annotation surface 106, the feedback generator 416 can cause the display included in the head-mounted device 104 to generate a shape or icon indicating the distance, as shown and described with respect to FIG. 2A. If the virtual annotation surface 106 is between the user 102 and the hand 108 and/or portion of the hand 108, then the feedback generator 416 can cause a portion of the virtual annotation surface 106 to cover and/or obscure a portion of the hand 108 that is beyond the virtual annotation surface 106, as shown and described with respect to FIG. 2B.

In some implementations, the feedback generated by the feedback generator 416 includes writing 420. The feedback generator 416 can generate and/or present writing 420 when the action determiner 414 determines that the computing device 400 and/or head-mounted device 104 should generate and/or present writing. The action determiner 414 can determine that the feedback generator 416 should generate and/or present writing 420 based on the gesture recognizer 410 recognizing a gesture associated with writing (such as a pinch), the location determiner 412 determining that the hand 108 and/or portion of the hand 108 is within the threshold distance of the virtual annotation surface 106, and/or the acceleration processor 408 determining that the hand 108 and/or portion of the hand 108 is moving.

The computing device 400 can include a stroke generator 422. When the feedback generator 416 generates and/or presents present writing 420, the stroke generator 422 can generate one or more strokes. The one or more strokes can be virtual strokes. The stroke generator 422 can generate one or more strokes on the virtual annotation surface 106. The stroke generator 422 can generate one or more strokes on the virtual annotation surface 106 by presenting lines, curves, or other paths on the virtual annotation surface 106 corresponding to the pattern of movement of the hand 108 and/or portion of the hand 108 with respect to the virtual annotation surface 106.

The computing device 400 can include at least one processor 424. The at least one processor 424 can execute instructions, such as instructions stored in at least one memory device 426, to cause the computing device 400 to perform any combination of methods, functions, and/or techniques described herein.

The computing device 400 can include at least one memory device 426. The at least one memory device 426 can include a non-transitory computer-readable storage medium. The at least one memory device 426 can store data and instructions thereon that, when executed by at least one processor, such as the processor 424, are configured to cause the computing device 400 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing device 400 can be configured to perform, alone, or in combination with the computing device 400, any combination of methods, functions, and/or techniques described herein. The at least one memory device 426 can include a gesture library. The gesture library can include predetermined gestures. The predetermined gestures can include hand formations and/or movements and associated actions.

The computing device 400 may include at least one input/output node 428. The at least one input/output node 428 may receive and/or send data, such as from and/or to, a server, and/or may receive input and provide output from and to a user. The input and output functions may be combined into a single node, or may be divided into separate input and output nodes. The input/output node 428 can include a microphone, a camera (such as a front-facing camera), an IMU, a display, a speaker, a microphone, one or more buttons, and/or one or more wired or wireless interfaces for communicating with other computing devices such as the head-mounted device 104, the wearable device 114, and/or a computing device in communication with the head-mounted device 104 and/or wearable device 114.

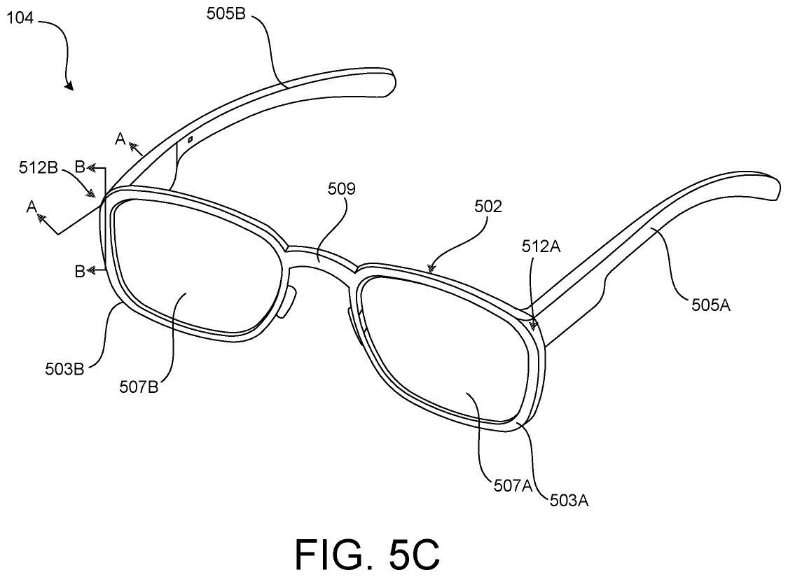

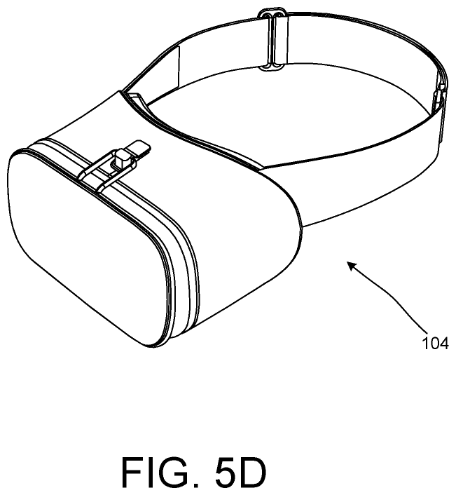

FIGS. 5A, 5B, and 5C show an implementation of the head-mounted device 104. As shown in FIGS. 5A, 5B, and 5C, the head-mounted device 104 includes a frame 502. The frame 502 includes a front frame portion defined by rim portions 503A, 503B surrounding respective optical portions in the form of lenses 507A, 507B, with a bridge portion 509 connecting the rim portions 503A, 503B. Arm portions 505A, 505B are coupled pivotably or rotatably coupled, to the front frame by hinge portions 512A, 512B at the respective rim portion 503A, 503B. In some implementations, the lenses 507A, 507B may be corrective/prescription lenses. In some implementations, the lenses 507A, 507B may be an optical material including glass and/or plastic portions that do not necessarily incorporate corrective/prescription parameters. Displays 510A, 510B may be coupled in a portion of the frame 502. In the implementation shown in FIG. 5B, the displays 510A, 510B are coupled in the arm portions 505A, 505B and/or rim portions 503A, 503B of the frame 502. In some implementations, the head-mounted device 104 can also include an audio output device 516 (such as one or more speakers), an illumination device 518, at least one processor 511, an outward-facing image sensor 514 (or camera), and gaze-tracking cameras 519A, 519B that can capture images of eyes of the user 102 to track a gaze of the user 102. In some implementations, the head-mounted device 104 may include a see-through near-eye display. The displays 510A, 510B may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world through the lenses 507A, 507B, next to content (such as digital images, user interface elements, virtual content, and the like) generated by the displays 510A, 510B. In some implementations, waveguide optics may be used to depict content on the displays 510A, 510B via outcoupled light 520A, 520B. The images projected by the displays 510A, 510B onto the lenses 507A, 507B may be translucent, allowing the user 102 to see the images projected by the displays 510A, 510B as well as physical objects beyond the head-mounted device 104.

FIG. 5D shows another implementation of the head-mounted device 104. In this implementation, the head-mounted device 104 is in goggle form, with a display included in the head-mounted device 104 and a housing supporting the display enclosing the face and/or eyes of the user 102. This implementation of the head-mounted device 104 can support a virtual reality (VR) experience in which the user 102 sees only what is presented by the display included in the head-mounted device 104.

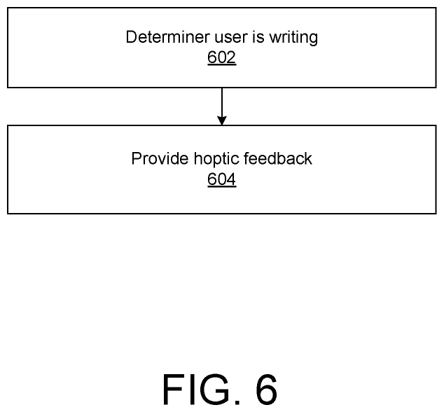

FIG. 6 is a flowchart of a method for providing feedback in response to a gesture. The method can be performed by the computing device 400, such as the head-mounted device 104. The method can include determining that a user 102 is writing (602). Determining that the user 102 is writing (602) can include determining that the user is writing on a virtual annotation surface 106 based on a portion of a hand 108 of the user 102 being within a threshold distance of the virtual annotation surface 106 and the hand 108 forming a predetermined gesture. The method can include providing haptic feedback (604). Providing haptic feedback (604 can include, based on determining that the user 102 is writing on the virtual annotation surface 106, providing haptic feedback to the user 102.

In some examples, the method further includes presenting a virtual stroke on the virtual annotation surface based on locations of the portion of the hand of the user and the determining that the user is writing on the virtual annotation surface.

In some examples, the haptic feedback includes vibration performed by a band worn on a wrist of the user.

In some examples, wherein the determining that the user is writing on the virtual annotation surface is based on the portion of the hand of the user being within the threshold distance of the virtual annotation surface, the hand forming the predetermined gesture, and the portion of the hand moving while remaining within the threshold distance of the virtual annotation surface.

In some examples, the method further includes determining that the portion of the hand was moving based on accelerometer measurements.

In some examples, the method further includes, before determining that the user is writing on the virtual annotation surface, presenting an indicator of a distance of the portion of the hand of the user from the virtual annotation surface.

In some examples, a size of the indicator of the distance of the portion of the hand is a function of the distance of the portion of the hand of the user from the virtual annotation surface.

In some examples, the method further includes determining a location of the portion of the hand based on an image captured by a camera included in the computing device.

In some examples, the predetermined gesture includes a pinching gesture.

In some examples, the predetermined gesture includes a tap.

In some examples, the method further includes presenting the virtual annotation surface within a head-mounted display.

In some examples, the computing device includes a head-mounted computing device.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Implementations of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A method performed by a computing device, the method comprising:
determining that a user is writing on a virtual annotation surface based on a portion of a hand of the user being within a threshold distance of the virtual annotation surface and the hand forming a predetermined gesture; and
based on determining that the user is writing on the virtual annotation surface, providing haptic feedback to the user.

2. The method of claim 1, further comprising presenting a virtual stroke on the virtual annotation surface based on locations of the portion of the hand of the user and the determining that the user is writing on the virtual annotation surface.

3. The method of claim 1, wherein the haptic feedback includes vibration performed by a band worn on a wrist of the user.

4. The method of claim 1, wherein the determining that the user is writing on the virtual annotation surface is based on:
the portion of the hand of the user being within the threshold distance of the virtual annotation surface;
the hand forming the predetermined gesture; and
the portion of the hand moving while remaining within the threshold distance of the virtual annotation surface.

5. The method of claim 4, further comprising determining that the portion of the hand was moving based on accelerometer measurements.

6. The method of claim 1, further comprising, before determining that the user is writing on the virtual annotation surface, presenting an indicator of a distance of the portion of the hand of the user from the virtual annotation surface.

7. The method of claim 6, wherein a size of the indicator of the distance of the portion of the hand is a function of the distance of the portion of the hand of the user from the virtual annotation surface.

8. The method of claim 1, further comprising determining a location of the portion of the hand based on an image captured by a camera included in the computing device.

9. The method of claim 1, wherein the predetermined gesture includes a pinching gesture.

10. The method of claim 1, wherein the predetermined gesture includes a tap.

11. The method of claim 1, further comprising presenting the virtual annotation surface within a head-mounted display.

12. The method of claim 1, wherein the computing device includes a head-mounted computing device.

13. A non-transitory computer-readable storage medium comprising instructions stored thereon that, when executed by at least one processor, are configured to cause a computing device to:
determine that a user is writing on a virtual annotation surface based on a portion of a hand of the user being within a threshold distance of the virtual annotation surface and the hand forming a predetermined gesture; and
based on determining that the user is writing on the virtual annotation surface, provide haptic feedback to the user.

14. A computing device comprising:
at least one processor; and
a non-transitory computer-readable storage medium comprising instructions stored thereon that, when executed by the at least one processor, are configured to cause the computing device to:
determine that a user is writing on a virtual annotation surface based on a portion of a hand of the user being within a threshold distance of the virtual annotation surface and the hand forming a predetermined gesture; and
based on determining that the user is writing on the virtual annotation surface, provide haptic feedback to the user.

15. The computing device of claim 14, wherein the instructions are further configured to cause the computing device to present a virtual stroke on the virtual annotation surface based on locations of the portion of the hand of the user and the determination that the user is writing on the virtual annotation surface.

16. The computing device of claim 14, wherein the haptic feedback includes vibration performed by a band worn on a wrist of the user.

17. The computing device of claim 14, wherein the determination that the user is writing on the virtual annotation surface is based on:
the portion of the hand of the user being within the threshold distance of the virtual annotation surface;
the hand forming the predetermined gesture; and
the portion of the hand moving while remaining within the threshold distance of the virtual annotation surface.

18. The non-transitory computer-readable storage medium of claim 13, wherein the instructions are further configured to cause the computing device to present a virtual stroke on the virtual annotation surface based on locations of the portion of the hand of the user and the determination that the user is writing on the virtual annotation surface.

19. The non-transitory computer-readable storage medium of claim 13, wherein the haptic feedback includes vibration performed by a band worn on a wrist of the user.

20. The non-transitory computer-readable storage medium of claim 13, wherein the determination that the user is writing on the virtual annotation surface is based on:
the portion of the hand of the user being within the threshold distance of the virtual annotation surface;
the hand forming the predetermined gesture; and
the portion of the hand moving while remaining within the threshold distance of the virtual annotation surface.
